(19) United States
(12) Patent Application Publication
(10) Pub. No.: US 2025/0292790 A1
(43) Pub. Date: Sep. 18, 2025

(54) MAGNETIC HEAD AND MAGNETIC RECORDING DEVICE

(71) Applicants: KABUSHIKI KAISHA TOSHIBA, Tokyo (JP); TOSHIBA ELECTRONIC DEVICES & STORAGE CORPORATION, Tokyo (JP)

(72) Inventors: Yuji NAKAGAWA, Kawasaki (JP); Masayuki TAKAGISHI, Tokyo (JP); Naoyuki NARITA, Funabashi (JP); Tomoyuki MAEDA, Kawasaki (JP); Ryo OSAMURA, Kawasaki (JP); Junki NUMATA, Yokohama (JP)

(21) Appl. No.: 19/012,256

(22) Filed: Jan. 7, 2025

(30) Foreign Application Priority Data
Mar. 14, 2024 (JP) 2024-040248

(51) Int. Cl. G11B 5/31

(52) U.S. Cl. CPC G11B 5/3116

(57) ABSTRACT

According to one embodiment, a magnetic head includes a first magnetic pole including a medium facing face and a first face crossing the medium facing face, a second magnetic pole including a second face, and a magnetic element. The first face faces the second face in a first direction. The magnetic element includes first and second magnetic layers. The first face includes first and second portions. A second direction crosses the medium facing face and the first direction. The first and second portions satisfy one of first and second conditions. In the first condition, a first portion position of the first portion is between a medium facing face position of the medium facing face and a second portion position of the second portion in the second direction. In the second condition, the second portion position is between the medium facing face position and the first portion position.

### CROSS-REFERENCE TO RELATED APPLICATIONS

This application is based upon and claims the benefit of priority from Japanese Patent Application No. 2024-040248, filed on Mar. 14, 2024; the entire contents of which are incorporated herein by reference.

### FIELD

Embodiments described herein relate generally to a magnetic head and a magnetic recording device.

### BACKGROUND

Information is recorded on a magnetic recording medium such as an HDD (Hard Disk Drive) using a magnetic head. It is desired to improve the characteristics of magnetic heads.

### BRIEF DESCRIPTION OF THE DRAWINGS

FIGS. 1A and 1B are schematic cross-sectional views illustrating a magnetic head according to a first embodiment;

FIG. 2 is a schematic plan view illustrating the magnetic head according to the first embodiment;

FIG. 3 is a schematic cross-sectional view illustrating the magnetic head according to the first embodiment;

FIG. 4 is a schematic cross-sectional view illustrating a magnetic head according to the first embodiment;

FIG. 5 is a schematic cross-sectional view illustrating a magnetic head according to the first embodiment;

FIG. 6 is a schematic cross-sectional view illustrating a magnetic head according to the first embodiment;

FIG. 7 is a schematic cross-sectional view illustrating a magnetic head according to the first embodiment;

FIG. 8 is a schematic cross-sectional view illustrating a magnetic head according to the first embodiment;

FIG. 9 is a schematic cross-sectional view illustrating a magnetic head according to the first embodiment;

FIG. 10 is a schematic cross-sectional view illustrating a magnetic head according to the first embodiment;

FIG. 11 is a schematic cross-sectional view illustrating a magnetic head according to the first embodiment;

FIG. 12 is a schematic cross-sectional view illustrating a magnetic head according to the first embodiment;

FIG. 13 is a schematic cross-sectional view illustrating a magnetic head according to the first embodiment;

FIG. 14 is a schematic cross-sectional view illustrating a magnetic head according to the first embodiment;

FIG. 15 is a schematic cross-sectional view illustrating a magnetic head according to the first embodiment;

FIGS. 16A and 16B are schematic views illustrating a magnetic head according to the first embodiment;

FIGS. 17A and 17B are schematic views illustrating the magnetic head according to the first embodiment;

FIGS. 18A and 18B are schematic views illustrating a magnetic head according to a second embodiment;

FIG. 19 is a schematic plan view illustrating a magnetic head according to the second embodiment;

FIG. 20 is a schematic plan view illustrating a magnetic head according to the second embodiment;

FIG. 21 is a schematic plan view illustrating a magnetic head according to the second embodiment;

FIG. 22 is a schematic plan view illustrating a magnetic head according to the second embodiment;

FIG. 23 is a schematic plan view illustrating a magnetic head according to the second embodiment;

FIG. 24 is a schematic perspective view illustrating a magnetic recording device according to an embodiment;

FIG. 25 is a schematic perspective view illustrating a part of the magnetic recording device according to the embodiment;

FIG. 26 is a schematic perspective view illustrating the magnetic recording device according to the embodiment; and

FIGS. 27A and 27B are schematic perspective views illustrating a part of the magnetic recording device according to the embodiment.

### DETAILED DESCRIPTION

According to one embodiment, a magnetic head includes a first magnetic pole, a second magnetic pole, and a magnetic element. The first magnetic pole includes a medium facing face and a first face crossing the medium facing face. The second magnetic pole includes a second face. The first face faces the second face in a first direction. The magnetic element is provided between the first face and the second face. The magnetic element includes a first magnetic layer, and a second magnetic layer provided between the first magnetic layer and the second magnetic pole. The first face includes a first portion and a second portion. A second direction crosses the medium facing face and crosses the first direction. The first portion and the second portion satisfy one of a first condition and a second condition. A first portion position of the first portion in the second direction is between a medium facing face position of the medium facing face in the second direction and a second portion position of the second portion in the second direction in the first condition. The second portion position is between the medium facing face position and the first portion position in the second condition. A first distance along the first direction between the first portion and the second face is shorter than a second distance along the first direction between the second portion and the second face.

Various embodiments are described below with reference to the accompanying drawings.

The drawings are schematic and conceptual; and the relationships between the thickness and width of portions, the proportions of sizes among portions, etc., are not necessarily the same as the actual values. The dimensions and proportions may be illustrated differently among drawings, even for identical portions.

In the specification and drawings, components similar to those described previously or illustrated in an antecedent drawing are marked with like reference numerals, and a detailed description is omitted as appropriate.

### First Embodiment

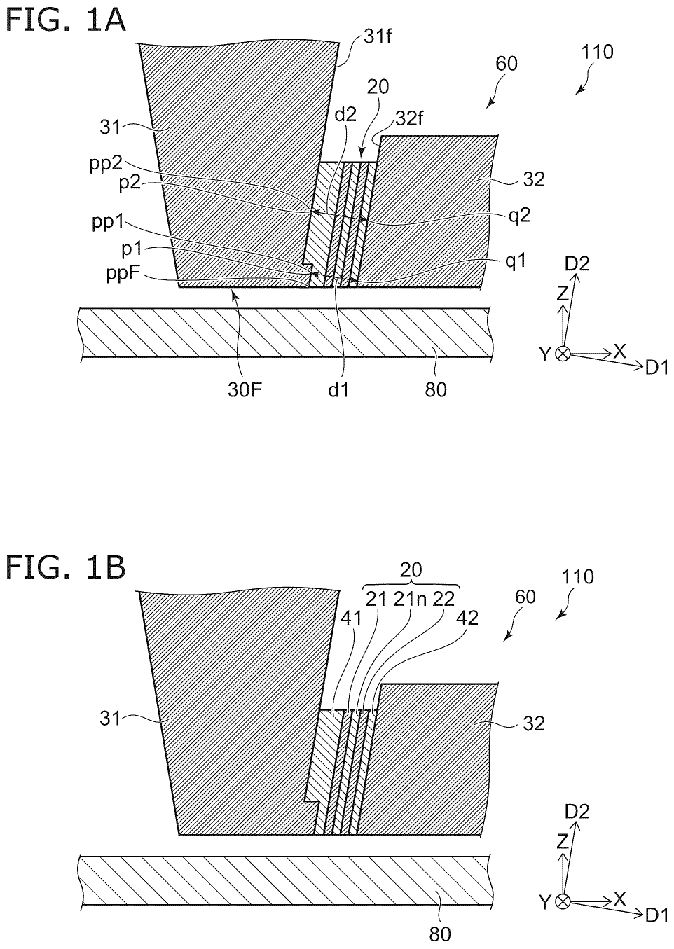

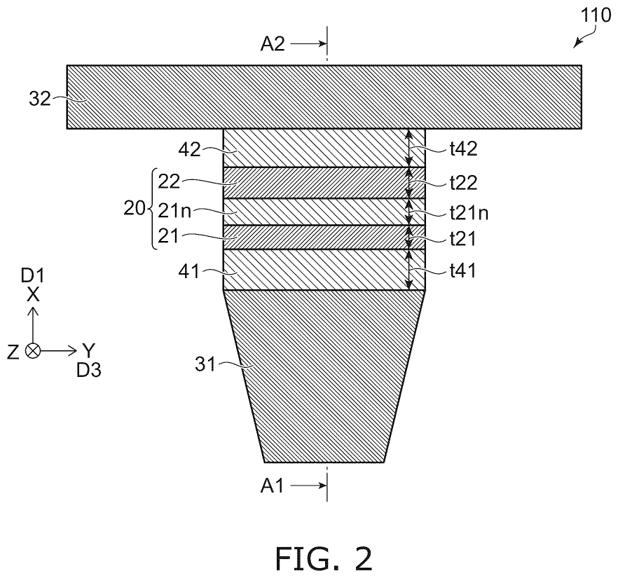

FIGS. 1A and 1B are schematic cross-sectional views illustrating a magnetic head according to a first embodiment.

FIG. 2 is a schematic plan view illustrating the magnetic head according to the first embodiment.

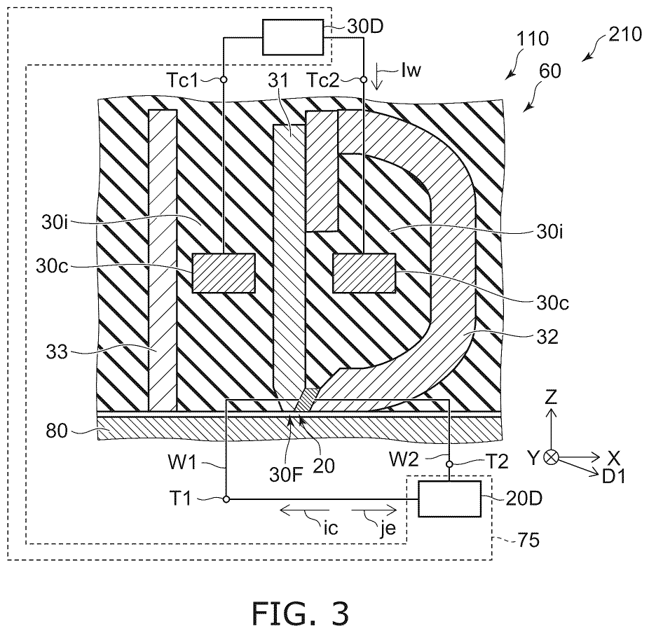

FIG. 3 is a schematic cross-sectional view illustrating the magnetic head according to the first embodiment.

FIGS. 1A, FIG. 1B, and FIG. 3 are cross-sectional views taken along the line A1-A2 in FIG. 2.

As shown in FIGS. 1A and 1B, a magnetic head 110 according to the embodiment includes a first magnetic pole 31, a second magnetic pole 32, and a magnetic element 20. The magnetic head 110 includes a recording section 60. The first magnetic pole 31, the second magnetic pole 32, and the magnetic element 20 are included in a recording section 60. As described later, the magnetic head 110 may include a reproducing section.

The first magnetic pole 31 includes a medium facing face 30F and a first face 31f. The first face 31f crosses the medium facing face 30F. FIG. 2 corresponds to a plan view viewed from the medium facing face 30F.

The medium facing face 30F is, for example, perpendicular to a Z-axis direction. One direction perpendicular to the Z-axis direction is defined as an X-axis direction. A direction perpendicular to the Z-axis direction and the X-axis direction is defined as a Y-axis direction.

The medium facing face 30F faces a magnetic recording medium 80. The medium facing face 30F corresponds to, for example, an ABS (Air Bearing Surface). The Z-axis direction corresponds to, for example, the height direction. The X-axis direction corresponds to, for example, the down-track direction. The Y-axis direction corresponds to, for example, the cross-track direction. The magnetic recording medium 80 and the magnetic head 110 move relative to each other along the down-track direction. A recording magnetic field generated from the magnetic head 110 is applied to a desired position on the magnetic recording medium 80. The magnetization at a desired position of the magnetic recording medium 80 is controlled in a direction according to the recording magnetic field. As a result, information is recorded on the magnetic recording medium 80.

The second magnetic pole 32 includes a second face 32f. The first face 31f faces the second face 32f in the first direction D1. A first direction D1 is, for example, along the X-axis direction. The first direction D1 may be inclined with respect to the X-axis direction. An angle of inclination may be, for example, more than 0 degrees and not more than 25 degrees.

The magnetic element 20 is provided between the first face 31f and the second face 32f. The magnetic element 20 includes a first magnetic layer 21 and a second magnetic layer 22. The second magnetic layer 22 is provided between the first magnetic layer 21 and the second magnetic pole 32.

As shown in FIG. 1B, the magnetic element 20 may include a first intermediate layer 21n. The first intermediate layer 21n is provided between the first magnetic layer 21 and the second magnetic layer 22. The first intermediate layer 21n is nonmagnetic. The first intermediate layer 21n is conductive. The first intermediate layer 21n includes, for example, at least one selected from the group consisting of Cu, Au, Cr, Al, V, and Ag. At least one of the first magnetic layer 21 or the second magnetic layer 22 includes at least one selected from the group consisting of Fe, Co, and Ni. These magnetic layers are, for example, ferromagnetic layers.

For example, the first magnetic pole 31 and the second magnetic pole 32 form a magnetic circuit. The first magnetic pole 31 is, for example, a main magnetic pole. The second magnetic pole 32 is, for example, a trailing shield. The first magnetic pole 31 may be a trailing shield, and the second magnetic pole 32 may be a main magnetic pole.

As shown in FIG. 3, the recording section 60 of the magnetic head 110 may further include a coil 30c. In this example, a part of the coil 30c is located between the first magnetic pole 31 and the second magnetic pole 32. In this example, a shield 33 is provided. The first magnetic pole 31 is located between the shield 33 and the second magnetic pole 32 in the X-axis direction. Another part of the coil 30c is located between the shield 33 and the first magnetic pole 31. An insulating section 30i is provided between these multiple elements. The shield 33 is, for example, a leading shield. The magnetic head 110 may include side shields (not shown).

As shown in FIG. 3, a recording current Iw is supplied from a recording circuit 30D to the coil 30c. For example, a first coil terminal Tc1 and a second coil terminal Tc2 are provided on the coil 30c. A recording current Iw is supplied to the coil 30c via these coil terminals. A recording magnetic field corresponding to the recording current Iw is applied to the magnetic recording medium 80 from the first magnetic pole 31.

As shown in FIG. 1B, the magnetic head 110 (recording section 60) may include a first nonmagnetic layer 41 and a second nonmagnetic layer 42. The first nonmagnetic layer 41 is provided between the first face 31f and the magnetic element 20.

The second nonmagnetic layer 42 is provided between the magnetic element 20 and the second face 32f. The first nonmagnetic layer 41 includes, for example, at least one selected from the group consisting of Cu, Au, Cr, Al, V, Ag, Ru, Ir, Ta, Rh, Pd, Pt, and W. The second nonmagnetic layer 42 includes, for example, at least one selected from the group consisting of Cu, Au, Cr, Al, V, Ag, Ru, Ir, Ta, Rh, Pd, Pt, and W. At least one of the first nonmagnetic layer 41 or the second nonmagnetic layer 42 may include at least one selected from the group consisting of Ru, Ir, Ta, Rh, Pd, Pt, and W, for example.

As shown in FIG. 3, the element circuit 20D is electrically connected to the magnetic element 20. In this example, the magnetic element 20 is electrically connected to the first magnetic pole 31 and the second magnetic pole 32. The magnetic head 110 is provided with a first terminal T1 and a second terminal T2. The first terminal T1 is electrically connected to one end of the magnetic element 20 via the first wiring W1 and the first magnetic pole 31. The second terminal T2 is electrically connected to the other end of the magnetic element 20 via the second wiring W2 and the second magnetic pole 32. For example, an element current ic is supplied to the magnetic element 20 from the element circuit 20D.

As shown in FIG. 3, in one operating state, the element current ic has a direction from the first magnetic pole 31 to the second magnetic pole 32. In this case, the electron flow je accompanying the element current ic has a direction from the second magnetic pole 32 to the first magnetic pole 31. The element current ic is, for example, a direct current.

As described above, a magnetic field (recording magnetic field) corresponding to the recording current Iw is generated between the first magnetic pole 31 and the second magnetic pole 32. The magnetic field is also applied to the magnetic element 20. The element current ic is supplied to the magnetic element 20 while the magnetic field is applied to the magnetic element 20.

For example, when the element current ic equal to or higher than a threshold value flows through the magnetic element 20, oscillation occurs in the magnetic layer included in the magnetic element 20. The magnetic element 20 functions as, for example, an STO (Spin-Torque Oscillator). Along with the oscillation, an alternating magnetic field (for example, a high frequency magnetic field) is generated from the magnetic element 20. The alternating magnetic field generated by the magnetic element 20 is applied to the magnetic recording medium 80 to assist recording on the magnetic recording medium 80. For example, MAMR (Microwave Assisted Magnetic Recording) can be implemented.

The controller 75 controls the recording circuit 30D and the element circuit 20D. A magnetic recording device 210 according to the embodiment includes the magnetic head 110 and the magnetic recording medium 80. The magnetic recording device 210 may include the recording circuit 30D, the element circuit 20D, and a controller 75. In the magnetic recording device 210, at least a recording operation is performed. In the recording operation, information is recorded on the magnetic recording medium 80 using the magnetic head 110.

As shown in FIG. 1A, the first face 31f includes a first portion p1 and a second portion p2. A second direction D2 crosses the medium facing face 30F and crosses the first direction D1. The second direction D2 may be perpendicular to the first direction D1.

The first portion p1 and the second portion p2 satisfy one of a first condition and a second condition. In the first condition, a first portion position pp1 of the first part p1 in the second direction D2 is between a medium facing face position ppF of the medium facing face 30 F in the second direction D2 and a second portion position pp2 of the second portion p2 in the second direction D2.

In the second condition, the second portion position pp2 is between the medium facing face position ppF and the first portion position pp1.

In the example of FIG. 1A, the first portion p1 and the second portion p2 satisfy the first condition. In the first condition, the medium facing face 30F, the first portion p1, and the second portion p2 are arranged in this order.

In the embodiment, a first distance d1 along the first direction D1 between the first portion p1 and the second face 32f is shorter than a second distance d2 along the first direction D1 between the second portion p2 and the second face 32f. At least a part of the magnetic element 20 overlaps the second portion p2 in the first direction D1. A part of the magnetic element 20 may overlap the first portion p1 in the first direction D1.

In this example, the first portion p1 protrudes toward the second face 32f with respect to the second portion p2. The first portion p1 is, for example, a protrusion. The second portion p2 is, for example, a recessed portion.

With such a configuration, for example, the magnetic field generated between the first magnetic pole 31 and the second magnetic pole 32 and passing through the magnetic element 20 is made uniform. Thereby, the magnetization in the magnetic element 20 is made uniform. For example, oscillation in the magnetic element 20 is made uniform. For example, strong oscillation strength can be obtained. For example, effective recording operations become possible. A magnetic head with improved characteristics can be provided.

The first portion p1 may be, for example, the end of the first face 31f.

In the embodiment, a ratio of the absolute value of the difference between the second distance d2 and the first distance d1 to the second distance d2 is, for example, not less than 0.05 and not more than 0.3. By the ratio of 0.05 or more, for example, the magnetic field passing through the magnetic element 20 is made uniform. For example, by the ratio of 0.3 or less, the distance between the first magnetic pole 31 and the second magnetic pole 32 is suppressed from becoming excessively large.

In the embodiment, a difference between the second distance d2 and the first distance d1 may be, for example, 2 nm or more.

As already explained, the first magnetic pole 31 and the second magnetic pole 32 may be electrically connected to the magnetic element 20. When the element current ic flows between the first magnetic pole 31 and the second magnetic pole 32, the electrical resistance between the first magnetic pole 31 and the second magnetic pole 32 is configured to oscillate. For example, electrical resistance changes substantially periodically. The frequency of oscillation (frequency of periodic changes) is, for example, not less than 10 GHz and not more than 50 GHz.

In the embodiment, a thickness t21 (see FIG. 2) of the first magnetic layer 21 along the first direction D1 may be, for example, not less than 3 nm and not more than 15 nm. A thickness t22 (see FIG. 2) of the second magnetic layer 22 along the first direction D1 may be, for example, not less than 3 nm and not more than 15 nm. A thickness t21n (see FIG. 2) of the first intermediate layer 21n along the first direction D1 may be, for example, not less than 1 nm and not more than 4 nm. A thickness t41 (see FIG. 2) of the first nonmagnetic layer 41 along the first direction D1 may be, for example, not less than 1 nm and not more than 8 nm. A thickness t42 (see FIG. 2) of the second nonmagnetic layer 42 along the first direction D1 may be, for example, not less than 1 nm and not more than 8 nm.

As shown in FIG. 1A, in the magnetic head 110, the second face 32f is substantially flat.

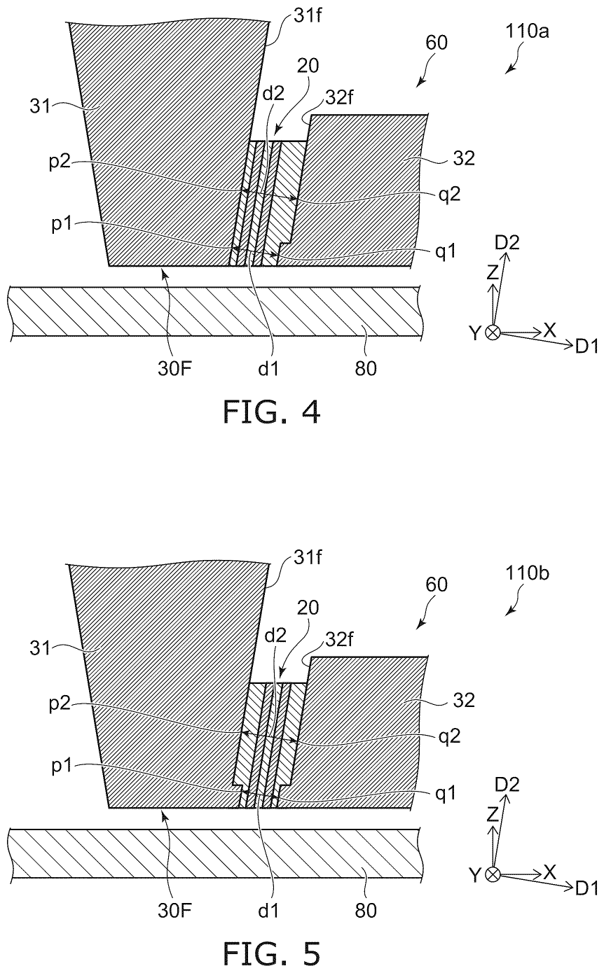

FIG. 4 is a schematic cross-sectional view illustrating a magnetic head according to the first embodiment.

As shown in FIG. 4, in a magnetic head 110a according to the embodiment, the shape of the first face 31f and the shape of the second face 32f are different from those in the magnetic head 110. The configuration of the magnetic head 110a except for this may be the same as the configuration of the magnetic head 110.

In the magnetic head 110a, the second face 32f includes a first opposing portion q1 and a second opposing portion q2. A direction from the first portion p1 to the first opposing portion q1 is along the first direction D1. A direction from the second portion p2 to the second opposing portion q2 is along the first direction D1. The first opposing portion q1 protrudes toward the first face 31f with respect to the second opposing portion q2.

In such a configuration, the first distance d1 is shorter than the second distance d2. The magnetic field passing through the magnetic element 20 is made uniform. Strong oscillation strength can be obtained and effective recording operation is possible. It is possible to improve the characteristics. The first opposing portion q1 may be, for example, an end portion of the second face 32f.

FIG. 5 is a schematic cross-sectional view illustrating a magnetic head according to the first embodiment.

As shown in FIG. 5, in a magnetic head 110b according to the embodiment, the first portion p1 protrudes toward the second face 32f with respect to the second portion p2. The first opposing portion q1 protrudes toward the first face 31f with respect to the second opposing portion q2. The configuration of the magnetic head 110b except for these may be the same as the configuration of the magnetic head 110 or the magnetic head 110a. In the magnetic head 110b as well, the magnetic field passing through the magnetic element 20 is made uniform. Strong oscillation strength can be obtained and effective recording operation is possible. It is possible to improve the characteristics.

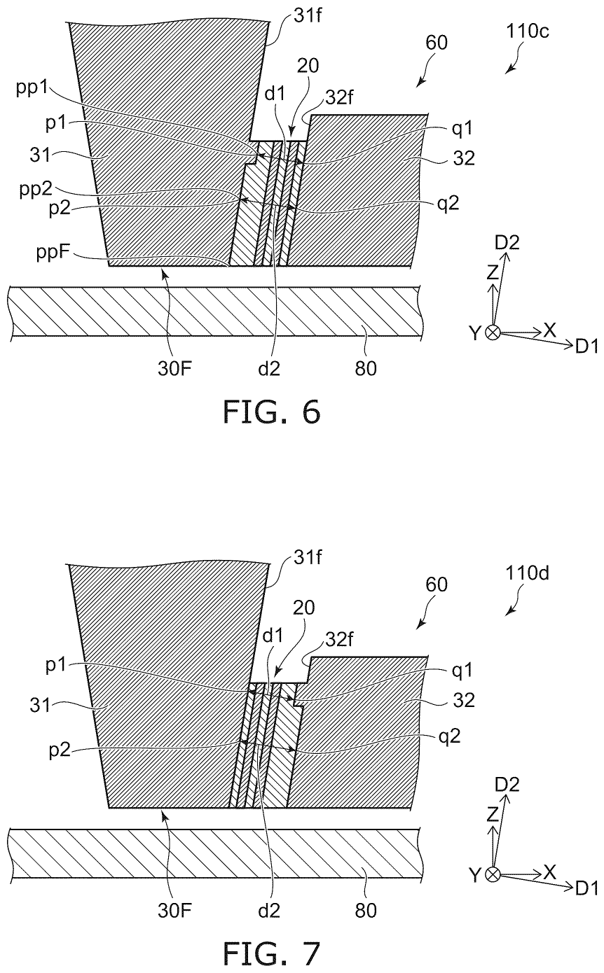

FIG. 6 is a schematic cross-sectional view illustrating a magnetic head according to the first embodiment.

As shown in FIG. 6, in a magnetic head 110c according to the embodiment, the shape of the first face 31f is different from that of the magnetic head 110. The configuration of the magnetic head 110c except for this may be the same as the configuration of the magnetic head 110.

In the magnetic head 110c, the first portion p1 and the second portion p2 satisfy the second condition. In the second condition, the second portion position pp2 is between the medium facing face position ppF and the first portion position pp1. In the magnetic head 110c as well, the first distance d1 is shorter than the second distance d2. The magnetic field passing through the magnetic element 20 is made uniform. It is possible to improve the characteristics.

FIG. 7 is a schematic cross-sectional view illustrating a magnetic head according to the first embodiment.

As shown in FIG. 7, in a magnetic head 110d according to the embodiment, the shape of the first face 31f and the shape of the second face 32f are different from those in the magnetic head 110c. The configuration of the magnetic head 110c except for these may be the same as the configuration of the magnetic head 110c.

The second condition is satisfied in the magnetic head 110d. The second face 32f includes the first opposing portion q1 and the second opposing portion q2. The direction from the first portion p1 to the first opposing portion q1 is along the first direction D1. The direction from the second portion p2 to the second opposing portion q2 is along the first direction D1. The first opposing portion q1 protrudes toward the first face 31f with respect to the second opposing portion q2.

In the magnetic head 110d, the first distance d1 is shorter than the second distance d2. The magnetic field passing through the magnetic element 20 is made uniform. It is possible to improve the characteristics.

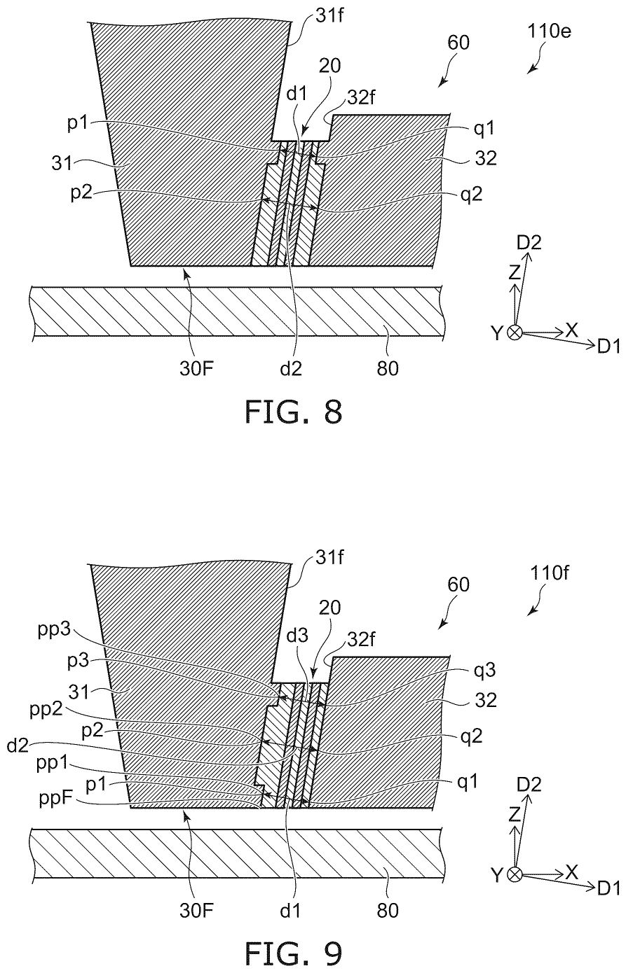

FIG. 8 is a schematic cross-sectional view illustrating a magnetic head according to the first embodiment.

As shown in FIG. 8, in a magnetic head 110e according to the embodiment, the first portion p1 protrudes toward the second face 32f with respect to the second portion p2. The first opposing portion q1 protrudes toward the first face 31f with respect to the second opposing portion q2. The configuration of the magnetic head 110e except for this may be the same as the configuration of the magnetic head 110c or 110d. The magnetic field passing through the magnetic element 20 is made uniform. It is possible to improve the characteristics.

FIG. 9 is a schematic cross-sectional view illustrating a magnetic head according to the first embodiment.

As shown in FIG. 9, in a magnetic head 110f according to the embodiment, the shape of the first face 31f is different from that of the magnetic head 110. The configuration of the magnetic head 110f except for this may be the same as the configuration of the magnetic head 110.

In the magnetic head 110f, the first face 31f further includes a third portion p3. The second portion position pp2 is between the first portion position pp1 and a third portion position pp3 of the third portion p3 in the second direction D2. A third distance d3 along the first direction D1 between the third portion p3 and the second face 32f is shorter than the second distance d2.

In the magnetic head 110f, the magnetic field passing through the magnetic element 20 is made uniform. For example, strong oscillation strength can be obtained. For example, effective recording operations become possible. A magnetic head with improved characteristics can be provided.

In the example of the magnetic head 110f, the third portion p3 protrudes toward the second face 32f with respect to the second portion p2. The third portion p3 is, for example, a protrusion.

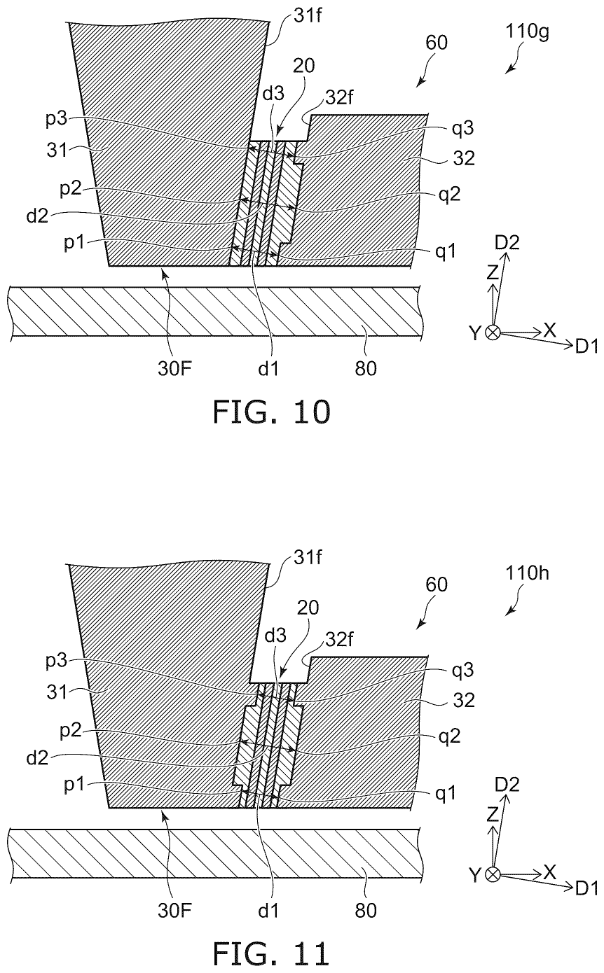

FIG. 10 is a schematic cross-sectional view illustrating a magnetic head according to the first embodiment.

As shown in FIG. 10, in a magnetic head 110g according to the embodiment, the shape of the second face 32f is different from that in the magnetic head 110. The configuration of the magnetic head 110g except for this may be the same as the configuration of the magnetic head 110.

In the magnetic head 110g, the second face 32f includes the first opposing portion q1, the second opposing portion q2, and a third opposing portion q3. The direction from the first portion p1 to the first opposing portion q1 is along the first direction D1. The direction from the second portion p2 to the second opposing portion q2 is along the first direction D1. A direction from the third portion p3 to the third opposing portion q3 is along the first direction D1. The first opposing portion q1 protrudes toward the first face 31f with respect to the second opposing portion q2. The third opposing portion q3 protrudes toward the first face 31f with respect to the second opposing portion q2. The third opposing portion q3 is, for example, a protrusion.

The magnetic field passing through the magnetic element 20 in the magnetic head 110g is made uniform. For example, strong oscillation strength can be obtained. For example, effective recording operations become possible. A magnetic head with improved characteristics can be provided.

FIG. 11 is a schematic cross-sectional view illustrating a magnetic head according to the first embodiment.

As shown in FIG. 11, in the magnetic head 110h according to the embodiment, the first portion p1 and the third portion p3 protrude toward the second face 32f with respect to the second portion p2. The first opposing portion q1 and the third opposing portion q3 protrude toward the first face 31f with respect to the second opposing portion q2. The configuration of the magnetic head 110h except for this may be the same as the configuration of the magnetic head 110. In the magnetic head 110h as well, for example, the magnetic field passing through the magnetic element 20 is made uniform. For example, effective recording operations become possible. A magnetic head with improved characteristics can be provided.

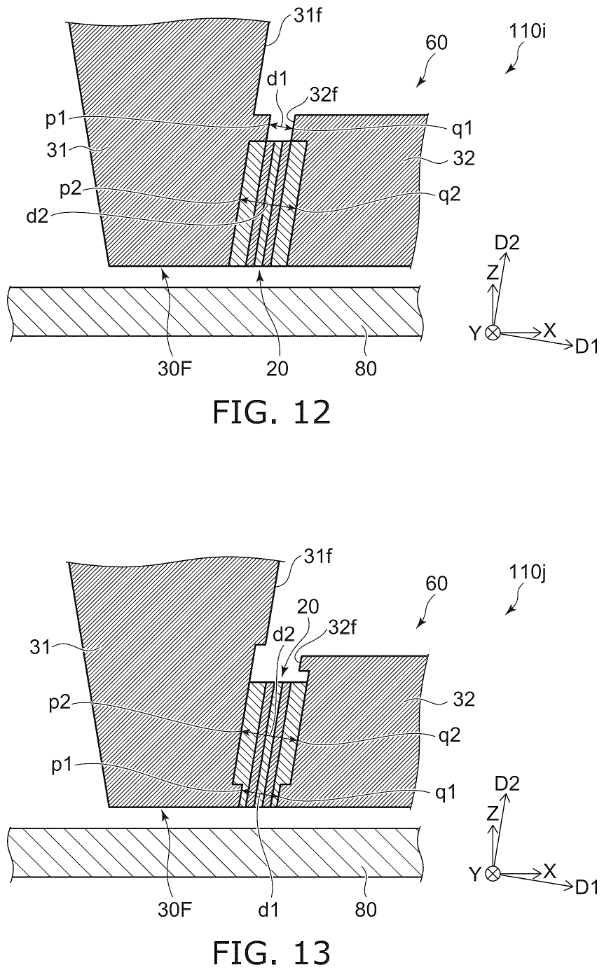

FIG. 12 is a schematic cross-sectional view illustrating a magnetic head according to the first embodiment.

As shown in FIG. 12, in a magnetic head 110i according to the embodiment, at least a part of the magnetic element 20 overlaps the first portion p1 in the second direction D2. At least a part of the magnetic element 20 overlaps the first opposing portion q1 in the second direction D2. The configuration of the magnetic head 110i except for this may be the same as the configuration of the magnetic head 110e. In the magnetic head 110e as well, the magnetic field passing through the magnetic element 20 is made uniform. For example, strong oscillation strength can be obtained. For example, effective recording operations become possible. A magnetic head with improved characteristics can be provided.

FIGS. 13 to 15 are schematic cross-sectional views illustrating magnetic heads according to the first embodiment.

In a magnetic head 110j illustrated in FIG. 13, the first portion p1 protrudes toward the second face 32f with respect to the second portion p2. The first opposing portion q1 protrudes toward the first face 31f with respect to the second opposing portion q2.

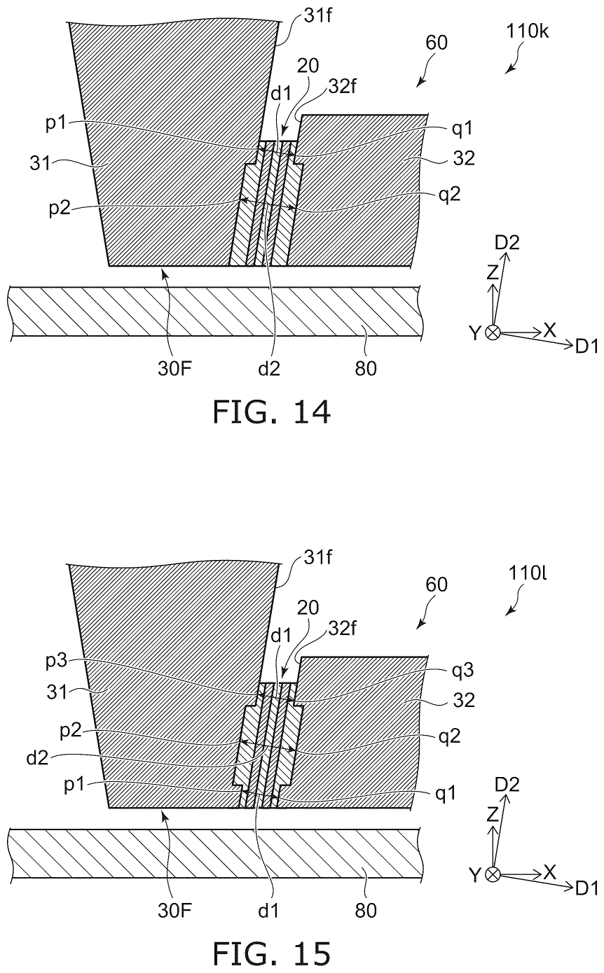

In a magnetic head 110k illustrated in FIG. 14, the first portion p1 protrudes toward the second face 32f with respect to the second portion p2. The first opposing portion q1 protrudes toward the first face 31f with respect to the second opposing portion q2.

In a magnetic head 110l illustrated in FIG. 15, the first portion p1 and the third portion p3 protrude toward the second face 32f with respect to the second portion p2. The first opposing portion q1 and the third opposing portion q3 protrude toward the first face 31f with respect to the second opposing portion q2.

In the magnetic head 110 and the magnetic heads 110a to 110l, the first face 31f and the second face 32f may be curved.

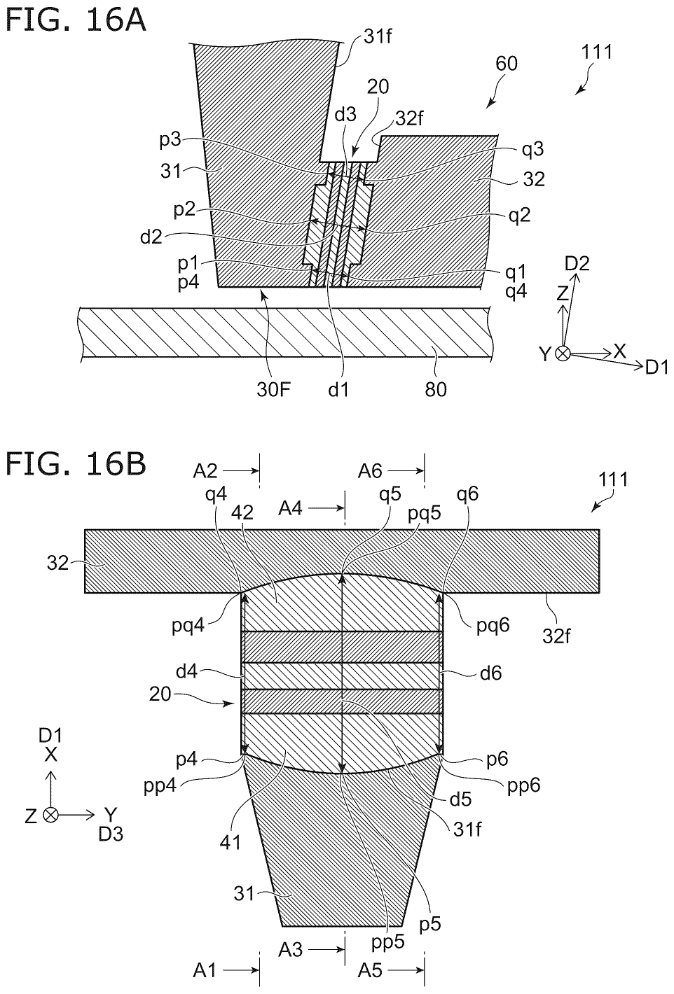

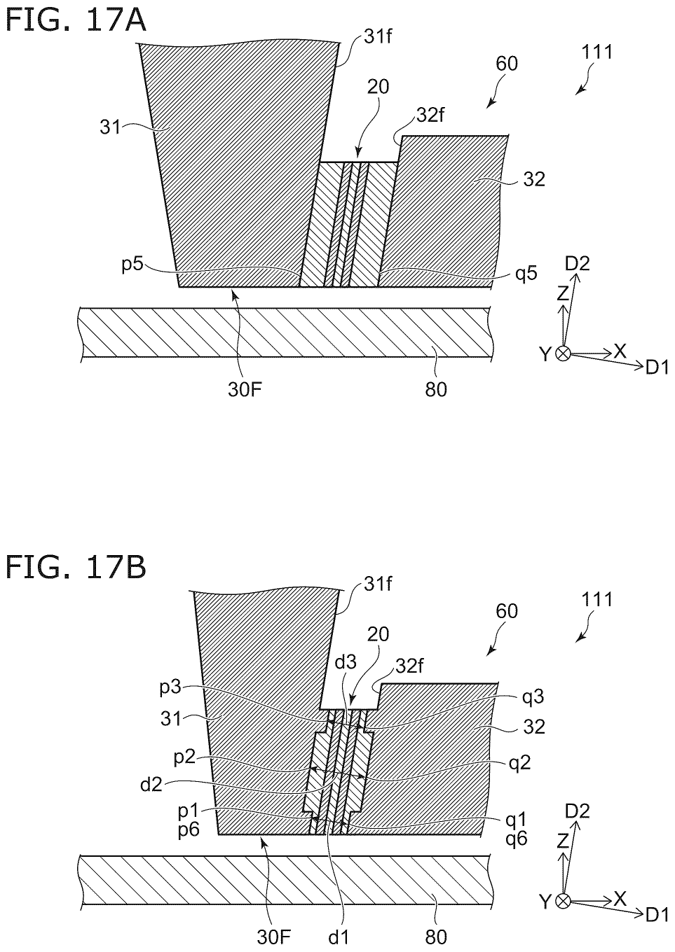

FIGS. 16A, 16B, 17A, and 17B are schematic views illustrating a magnetic head according to the first embodiment.

FIG. 16B is a schematic plan view. FIG. 16A is a sectional view taken along the line A1-A2 in FIG. 16B. FIG. 17A is a sectional view taken along line the A3-A4 in FIG. 16B. FIG. 17B is a sectional view taken along line A5-A6 in FIG. 16B.

As shown in FIG. 16B, in a magnetic head 111 according to the embodiment, the first face 31f includes a fourth portion p4, a fifth portion p5, and a sixth portion p6. The configuration of the magnetic head 111 except for this may be the same as the configuration of the magnetic head 110 or the magnetic heads 110a to 110l.

A third direction D3 is along the medium facing face 30F and cross the first direction D1. The third direction D3 may be, for example, the Y-axis direction.

A fifth portion position pp5 of the fifth portion p5 in the third direction D3 is between a fourth portion position pp4 of the fourth portion p4 in the third direction D3 and a sixth portion position pp6 of the sixth portion p6 in the third direction D3. A fourth distance d4 along the first direction D1 between the fourth portion p4 and the second face 32f is shorter than a fifth distance d5 along the first direction D1 between the fifth portion p5 and the second face 32f. A sixth distance d6 along the first direction D1 between the sixth portion p6 and the second face 32f is shorter than the fifth distance d5.

By such a configuration, the magnetic field passing through the magnetic element 20 is made uniform in the X-Y plane. For example, strong oscillation strength can be obtained. For example, effective recording operations become possible. A magnetic head with improved characteristics can be provided.

In the magnetic head 111, the fifth portion p5 is recessed with respect to the fourth portion p4 and the sixth portion p6.

In the magnetic head 111, the second face 32f includes a fourth opposing portion q4, a fifth opposing portion q5, and a sixth opposing portion q6. A fifth opposing portion position pq5 of the fifth opposing portion q5 in the third direction D3 is between a fourth opposing portion position pq4 of the fourth opposing portion q4 in the third direction D3 and a sixth opposing portion position pq6 of the sixth opposing portion q6 in the third direction D3. The fifth opposing portion q5 is recessed with respect to the fourth opposing portion q4 and the sixth opposing portion q6.

In the magnetic head 111, a distance between the fourth portion p4 and the sixth portion p6 in the third direction D3 may be longer than the length of the magnetic element 20 in the third direction D3 (magnetic element length). This distance may be the same as the magnetic element length. This distance may be shorter than the magnetic element length.

### Second Embodiment

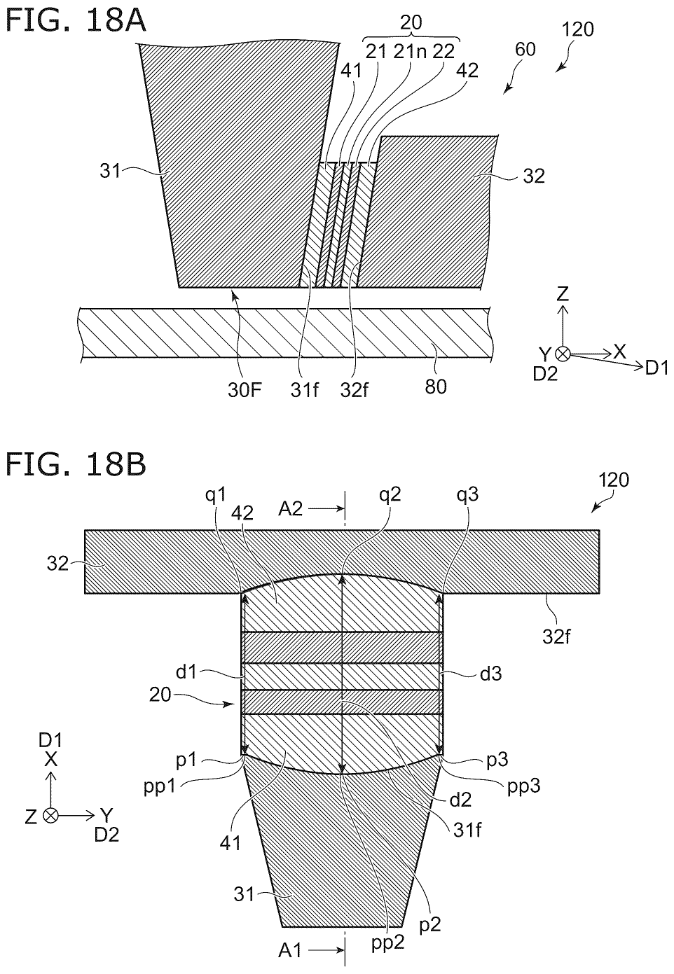

FIGS. 18A and 18B are schematic views illustrating a magnetic head according to the second embodiment.

FIG. 18B is a schematic plan view. FIG. 18A is a sectional view taken along the line A1-A2 in FIG. 18B.

As shown in FIG. 18B, a magnetic head 120 according to the embodiment includes the first magnetic pole 31, the second magnetic pole 32, and the magnetic element 20. In the magnetic head 120, the second direction D2 is along the medium facing face 30F and crosses the first direction D1. The configuration of the magnetic head 120 except for this may be the same as the configuration of the magnetic head according to the first embodiment.

The magnetic head 120 includes the first magnetic pole 31, the second magnetic pole 32, and the magnetic element 20. The first magnetic pole 31 includes the medium facing face 30F and the first face 31f that crosses the medium facing face 30F. The second magnetic pole 32 includes a second face 32f. The first face 31f faces the second face 32f in the first direction D1.

The magnetic element 20 is provided between the first face 31f and the second face 32f. The magnetic element 20 includes the first magnetic layer 21 and the second magnetic layer 22 provided between the first magnetic layer 21 and the second magnetic pole 32. The magnetic element 20 may include the first intermediate layer 21n. The first intermediate layer 21n is provided between the first magnetic layer 21 and the second magnetic layer 22.

As shown in FIG. 18B, the first face 31f includes the first portion p1, the second portion p2, and the third portion p3. The second direction D2 is along the medium facing face 30F and crosses the first direction D1. The second direction D2 may be, for example, the Y-axis direction.

The second portion position pp2 of the second portion p2 in the second direction D2 is between the first portion position pp1 of the first portion p1 in the second direction D2 and the third portion position pp3 of the third portion p3 in the second direction D2.

The first distance d1 along the first direction D1 between the first portion p1 and the second face 32f is shorter than the second distance d2 along the first direction D1 between the second portion p2 and the second face 32f. The third distance d3 along the first direction D1 between the third portion p3 and the second face 32f is shorter than the second distance d2.

For example, the second portion p2 is recessed with respect to the first portion p1. The second portion p2 is recessed with respect to the third portion p3. The second portion p2 is, for example, a recess. The first portion p1 and the third portion p3 are, for example, protrusions.

In the magnetic head 120, at least a part of the magnetic element 20 is located between the second portion p2 and the second face 32f.

In the magnetic head 120 as well, for example, the magnetic field generated between the first magnetic pole 31 and the second magnetic pole 32 and passing through the magnetic element 20 is made uniform. Thereby, the magnetization in the magnetic element 20 is made uniform. For example, oscillation in the magnetic element 20 is made uniform. For example, strong oscillation strength can be obtained. For example, effective recording operations become possible. A magnetic head with improved characteristics can be provided.

In this example, the second face 32f includes the first opposing portion q1, the second opposing portion q2, and the third opposing portion q3. The direction from the first portion p1 to the first opposing portion q1 is along the first direction D1. The direction from the second portion p2 to the second opposing portion q2 is along the first direction D1. The direction from the third portion p3 to the third opposing portion q3 is along the first direction D1. The second opposing portion q2 is recessed with respect to the first opposing portion q1 and the third opposing portion q3.

In the embodiment, the first face 31f may be curved, and the second face 32f may be curved.

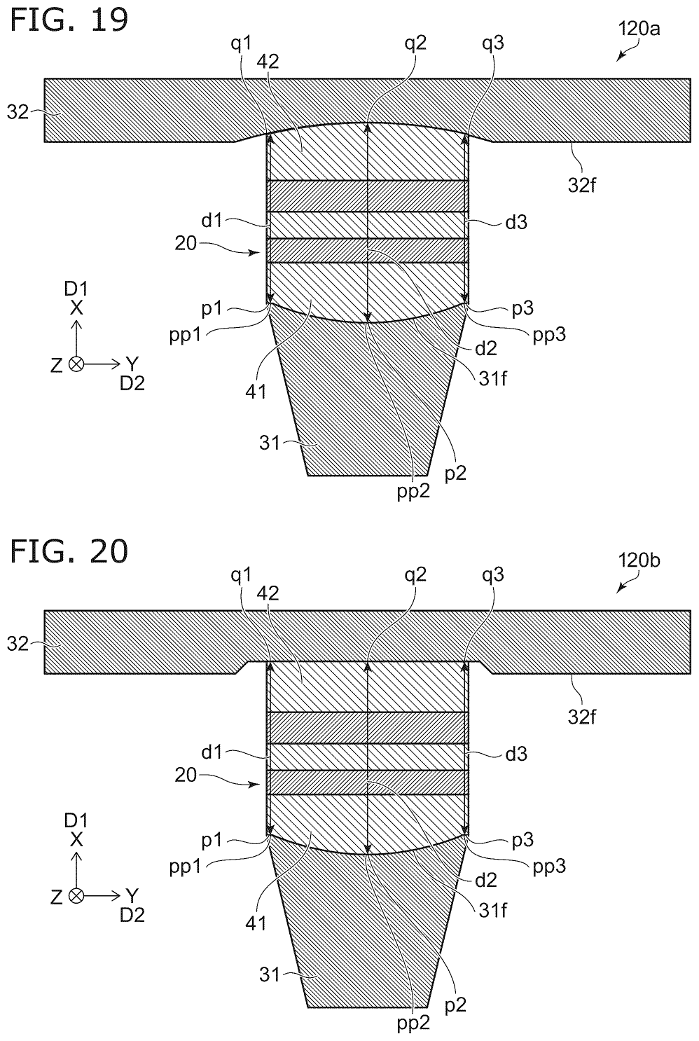

FIGS. 19 and 20 are schematic plan views illustrating a magnetic head according to the second embodiment.

As shown in FIG. 19, in a magnetic head 120a according to the embodiment, the first distance d1 is shorter than the second distance d2. The third distance d3 is shorter than the second distance d2.

As shown in FIG. 20, in the magnetic head 120b according to the embodiment, the first distance d1 is shorter than the second distance d2. The third distance d3 is shorter than the second distance d2. In the magnetic head 120b, a portion including the second opposing portion q2 may be substantially planar.

FIG. 21 is a schematic plan view illustrating a magnetic head according to the second embodiment.

As shown in FIG. 21, in a magnetic head 121 according to the embodiment, the width of the magnetic element 20 in the second direction D2 is different from that in the magnetic head 120. The configuration of the magnetic head 121 except for this may be the same as the configuration of the magnetic head 120.

In the magnetic head 121, the magnetic element 20 does not overlap the first portion p1 in the first direction D1, and does not overlap the third portion p3 in the first direction D1. By such a configuration, the state of the magnetic field passing through the magnetic element 20 is made more uniform. Characteristics can be made more stable. It is possible to improve the characteristics.

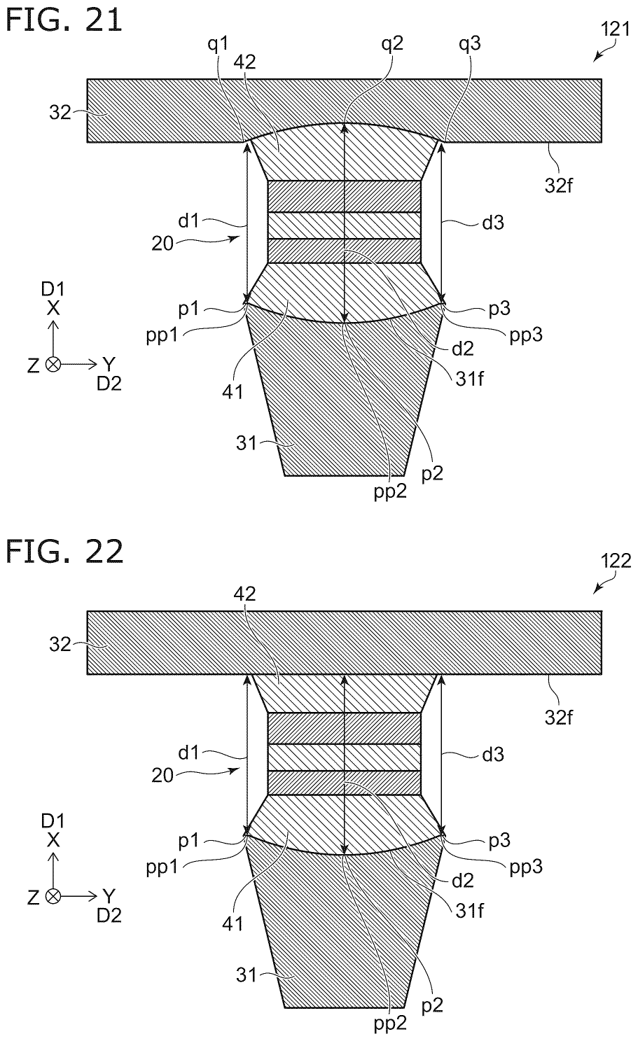

FIG. 22 is a schematic plan view illustrating a magnetic head according to the second embodiment.

As shown in FIG. 22, in a magnetic head 122 according to the embodiment, the shape of the second face 32f is different from that of the magnetic head 121. The configuration of the magnetic head 122 except for this may be the same as the configuration of the magnetic head 121. In the magnetic head 122, the second face 32f is substantially flat.

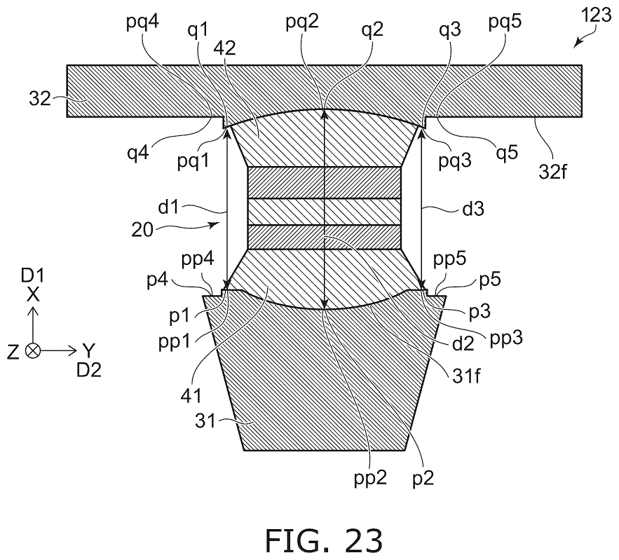

FIG. 23 is a schematic plan view illustrating a magnetic head according to the second embodiment.

As shown in FIG. 23, in a magnetic head 123 according to the embodiment, the shape of the first face 31f is different from that of the magnetic head 121. The configuration of the magnetic head 123 except for this may be the same as the configuration of the magnetic head 121.

In the magnetic head 123, the first face 31f further includes a fourth portion p4 and a fifth portion p5. The first portion position pp1 is between a fourth portion position pp4 of the fourth portion p4 and the second portion position pp2 in the second direction D2. The third portion position pp3 is between the second portion position pp2 and a fifth portion position pp5 of the fifth portion p5 in the second direction D2. The first portion p1 protrudes toward the second face 32f with respect to the fourth portion p4. The third portion p3 protrudes toward the second face 32f with respect to the fifth portion p5.

In the magnetic head 123, the second face 32f includes the first opposing portion q1, the second opposing portion q2, the third opposing portion q3, a fourth opposing portion q4, and a fifth opposing portion q5. The second opposing portion position pq2 of the second opposing portion q2 in the second direction D2 is between the first opposing portion position pq1 of the first opposing portion q1 in the second direction D2 and a third opposing portion position pq3 of the third opposing portion q3 in the second direction D2. The first opposing portion position pq1 is between a fourth opposing portion position pq4 of the fourth opposing portion q4 and the second opposing portion position pq2 in the second direction D2. The third opposing portion position pq3 is between the second opposing portion position pq2 and a fifth opposing portion position pq5 of the fifth opposing portion q5 in the second direction D2.

The first opposing portion q1 protrudes toward the first face 31f with respect to the fourth opposing portion q4. The third opposing portion q3 protrudes toward the first face 31f with respect to the fifth opposing portion q5.

Hereinafter, examples of other configurations regarding the magnetic recording device according to the embodiment will be described.

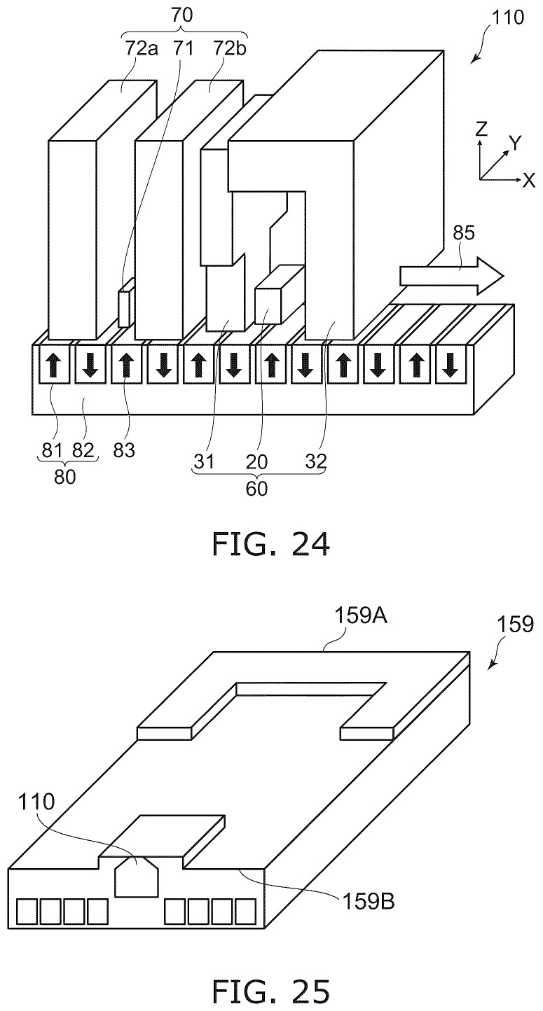

FIG. 24 is a schematic perspective view illustrating the magnetic recording device according to an embodiment.

As shown in FIG. 24, the magnetic head (e.g., magnetic head 110) according to the embodiment is used together with the magnetic recording medium 80. In this example, the magnetic head 110 includes the recording section 60 and the reproducing section 70. Information is recorded on the magnetic recording medium 80 by the recording section 60 of the magnetic head 110. The reproducing section 70 reproduces information recorded on the magnetic recording medium 80.

The magnetic recording medium 80 includes, for example, a medium substrate 82 and a magnetic recording layer 81 provided on the medium substrate 82. Magnetization 83 of the magnetic recording layer 81 is controlled by the recording section 60.

The reproducing section 70 includes, for example, a first reproducing magnetic shield 72a, a second reproducing magnetic shield 72b, and a magnetic reproducing element 71. The magnetic reproducing element 71 is provided between the first reproducing magnetic shield 72a and the second reproducing magnetic shield 72b. The magnetic reproducing element 71 can output a signal according to the magnetization 83 of the magnetic recording layer 81.

As shown in FIG. 24, the magnetic recording medium 80 moves relative to the magnetic head 110 in a medium movement direction 85. The magnetic head 110 controls information corresponding to the magnetization 83 of the magnetic recording layer 81 at an arbitrary position. The magnetic head 110 reproduces information corresponding to the magnetization 83 of the magnetic recording layer 81 at an arbitrary position.

FIG. 25 is a schematic perspective view illustrating a part of the magnetic recording device according to the embodiment.

FIG. 25 illustrates a head slider.

The magnetic head 110 is provided on a head slider 159. The head slider 159 includes, for example, Al₂O₃/TiC. The head slider 159 moves relative to the magnetic recording medium while flying over or in contact with the magnetic recording medium.

The head slider 159 has, for example, an air inflow side 159A and an air outflow side 159B. The magnetic head 110 is arranged on the side surface of the air outflow side 159B of the head slider 159. As a result, the magnetic head 110 moves relative to the magnetic recording medium while floating above or in contact with the magnetic recording medium.

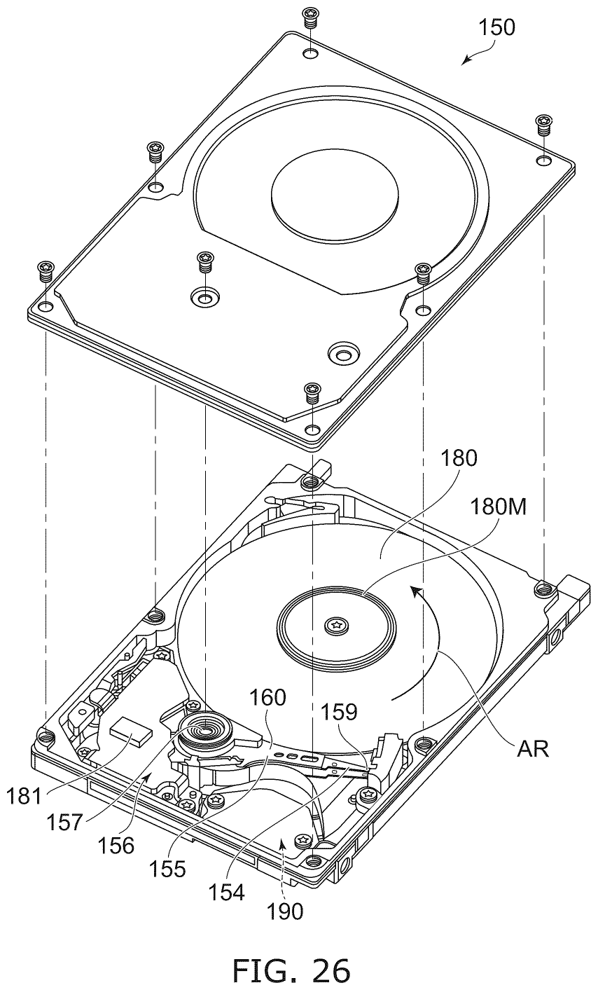

FIG. 26 is a schematic perspective view illustrating the magnetic recording device according to the embodiment.

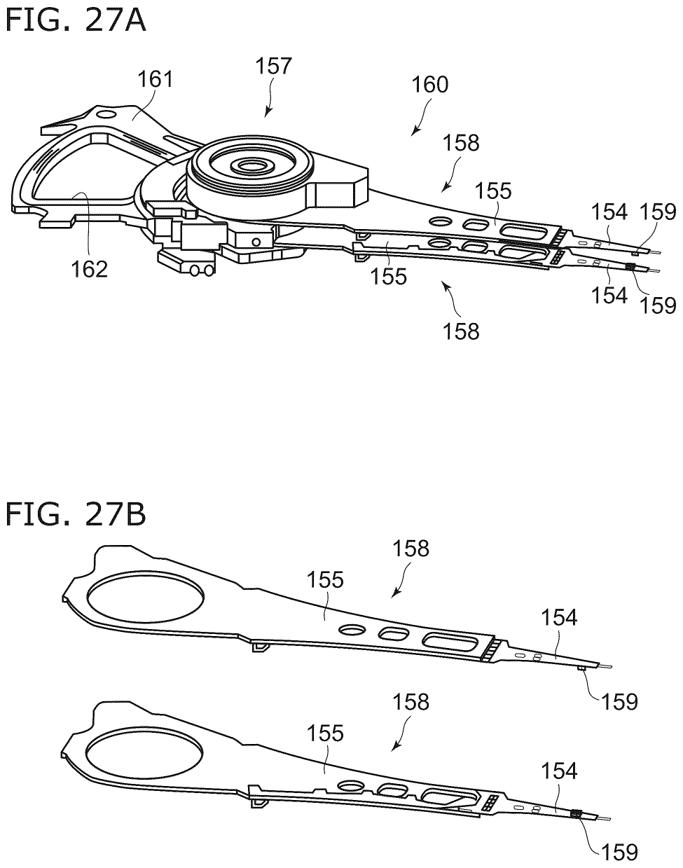

FIGS. 27A and 27B are schematic perspective views illustrating a part of the magnetic recording device according to the embodiment.

As shown in FIG. 26, in a magnetic recording device 150 according to the embodiment, a rotary actuator is used. The recording medium disk 180 is connected to a spindle motor 180M. The recording medium disk 180 is rotated in a direction of arrow AR by the spindle motor 180M. The spindle motor 180M is responsive to control signals from the drive device controller. The magnetic recording device 150 according to the embodiment may include the multiple recording medium disks 180. The magnetic recording device 150 may include a recording medium 181. The recording medium 181 is, for example, an SSD (Solid State Drive). A non-volatile memory such as a flash memory is used for the recording medium 181, for example. For example, the magnetic recording device 150 may be a hybrid HDD (Hard Disk Drive).

The head slider 159 records and reproduces information to be recorded on the recording medium disk 180. The head slider 159 is provided at an end of a thin-film suspension 154. A magnetic head according to the embodiment is provided near the end of the head slider 159.

While the recording medium disk 180 is rotating, the pressing pressure by the suspension 154 and the floating pressure generated at the medium facing face (ABS) of the head slider 159 are balanced. The distance between the medium facing face of the head slider 159 and the surface of the recording medium disk 180 is the predetermined fly height. In the embodiment, the head slider 159 may contact the recording medium disk 180. For example, a contact sliding type may be applied.

The suspension 154 is connected to one end of an arm 155 (e.g., an actuator arm). The arm 155 includes, for example, a bobbin part or the like. The bobbin part holds a drive coil. A voice coil motor 156 is provided at the other end of the arm 155. The voice coil motor 156 is a type of linear motor. The voice coil motor 156 includes, for example, a drive coil and a magnetic circuit. The drive coil is wound on the bobbin part of the arm 155. The magnetic circuit includes permanent magnets and opposing yokes. The drive coil is provided between the permanent magnet and the opposing yoke. The suspension 154 includes one end and the other end. The magnetic head is provided at one end of the suspension 154. The arm 155 is connected to the other end of the suspension 154.

The arm 155 is held by ball bearings. Ball bearings are provided at two locations above and below a bearing part 157. The arm 155 can be rotated and slid by the voice coil motor 156. The magnetic head can move to any position on the recording medium disk 180.

FIG. 27A is an enlarged perspective view of the head stack assembly 160, illustrating the configuration of a part of the magnetic recording device.

FIG. 27B is a perspective view illustrating the magnetic head assembly (head gimbal assembly: HGA) 158 that forms part of the head stack assembly 160.

As shown in FIG. 27A, the head stack assembly 160 includes the bearing part 157, the magnetic head assembly 158 and a support frame 161. The magnetic head assembly 158 extends from the bearing part 157. The support frame 161 extends from the bearing part 157. A direction in which the support frame 161 extends is opposite to a direction in which the magnetic head assembly 158 extends. The support frame 161 supports a coil 162 of the voice coil motor 156.

As shown in FIG. 27B, the magnetic head assembly 158 includes the arm 155 extending from the bearing part 157 and the suspension 154 extending from the arm 155.

The head slider 159 is provided at the end of the suspension 154. The head slider 159 is provided with the magnetic head according to the embodiment.

The magnetic head assembly 158 (head gimbal assembly) according to the embodiment includes the magnetic head according to the embodiment, the head slider 159 provided with the magnetic head, the suspension 154 and the arm 155. The head slider 159 is provided at one end of the suspension 154. The arm 155 is connected to the other end of the suspension 154.

The suspension 154 may include, for example, a wiring (not shown) for recording and reproducing signals. The suspension 154 may include, for example, a heater wiring (not shown) for adjusting the fly height. The suspension 154 may include a wiring (not shown) for, for example, an oscillator element or the like. These wires may be electrically connected to multiple electrodes provided on the magnetic head.

A signal processor 190 is provided in the magnetic recording device 150. The signal processor 190 uses a magnetic head to record and reproduce signals on a magnetic recording medium. Input/output lines of the signal processor 190 are connected to, for example, electrode pads of the magnetic head assembly 158 and electrically connected to the magnetic head.

The magnetic recording device 150 according to the embodiment includes the magnetic recording medium, the magnetic head according to the embodiment, a movable part, a position controller, and a signal processor. The movable part separates the magnetic recording medium from the magnetic head or makes them relatively movable while they are in contact with each other. The position controller aligns the magnetic head with a predetermined recording position on the magnetic recording medium. The signal processor records and reproduces signals on the magnetic recording medium using the magnetic head.

For example, the recording medium disk 180 is used as the above magnetic recording medium. The movable part includes, for example, the head slider 159. The position controller described above includes, for example, the magnetic head assembly 158.

The embodiments may include the following Technical proposals:

### (Technical Proposal 1)

A magnetic head, comprising:
a first magnetic pole including a medium facing face and a first face crossing the medium facing face;
a second magnetic pole including a second face, the first face facing the second face in a first direction; and
a magnetic element provided between the first face and the second face, the magnetic element including a first magnetic layer, and a second magnetic layer provided between the first magnetic layer and the second magnetic pole,
the first face including a first portion and a second portion,
a second direction crossing the medium facing face and crossing the first direction,
the first portion and the second portion satisfying one of a first condition and a second condition,
a first portion position of the first portion in the second direction being between a medium facing face position of the medium facing face in the second direction and a second portion position of the second portion in the second direction in the first condition,
the second portion position being between the medium facing face position and the first portion position in the second condition, and
a first distance along the first direction between the first portion and the second face being shorter than a second distance along the first direction between the second portion and the second face.

### (Technical Proposal 2)

The magnetic head according to Technical proposal 1, wherein
the first portion protrudes toward the second face with respect to the second portion.

### (Technical Proposal 3)

The magnetic head according to Technical proposal 1 or 2, wherein
the second face includes a first opposing portion and a second opposing portion,
a direction from the first portion to the first opposing portion is along the first direction,
a direction from the second portion to the second opposing portion is along the first direction, and
the first opposing portion protrudes toward the first face with respect to the second opposing portion.

### (Technical Proposal 4)

The magnetic head according to Technical proposal 3, wherein
at least a part of the magnetic element overlaps the first opposing portion in the second direction.

### (Technical Proposal 5)

The magnetic head according to Technical proposal 1 or 2, wherein
the first face further includes a third portion,
the second portion position is between the first portion position and a third portion position of the third portion in the second direction, and
a third distance between the third portion and the second face along the first direction is shorter than the second distance.

### (Technical Proposal 6)

The magnetic head according to Technical proposal 5, wherein
the third portion protrudes toward the second face with respect to the second portion.

### (Technical Proposal 7)

The magnetic head according to Technical proposal 5 or 6, wherein
the second face includes a first opposing portion, a second opposing portion, and a third opposing portion,
a direction from the first portion to the first opposing portion is along the first direction,
a direction from the second portion to the second opposing portion is along the first direction,
a direction from the third portion to the third opposing portion is along the first direction,
the first opposing portion protrudes toward the first face with respect to the second opposing portion, and
the third opposing portion protrudes toward the first face with respect to the second opposing portion.

### (Technical Proposal 8)

The magnetic head according to any one of Technical proposals 1-7, wherein
at least a part of the magnetic element overlaps the first portion in the second direction.

### (Technical Proposal 9)

The magnetic head according to any one of Technical proposals 1-8, wherein
the second direction is perpendicular to the first direction.

### (Technical Proposal 10)

The magnetic head according to any one of Technical proposals 1-9, wherein
a ratio of an absolute value of a difference between the second distance and the first distance to the second distance is not less than 0.05 and not more than 0.3.

### (Technical Proposal 11)

The magnetic head according to any one of Technical proposals 1-10, wherein
the magnetic element further includes a first intermediate layer being non-magnetic, the first intermediate layer being provided between the first magnetic layer and the second magnetic layer.

### (Technical Proposal 12)

The magnetic head according to any one of Technical proposals 1-11, wherein
the first face includes a fourth portion, a fifth portion, and a sixth portion,
a third direction is along the medium facing face and crosses the first direction;
a fifth portion position of the fifth portion in the third direction is between a fourth portion position of the fourth portion in the third direction and a sixth portion position of the sixth portion in the third direction,
a fourth distance along the first direction between the fourth portion and the second face is shorter than a fifth distance along the first direction between the fifth portion and the second face, and
a sixth distance along the first direction between the sixth portion and the second face is shorter than the fifth distance.

### (Technical Proposal 13)

The magnetic head according to Technical proposal 12, wherein
the fifth portion is recessed with respect to the fourth portion and the sixth portion.

### (Technical Proposal 14)

A magnetic head, comprising:
a first magnetic pole including a medium facing face and a first face crossing the medium facing face;
a second magnetic pole including a second face, the first face facing the second face in a first direction; and
a magnetic element provided between the first face and the second face, the magnetic element including a first magnetic layer, and a second magnetic layer provided between the first magnetic layer and the second magnetic pole,
the first face including a first portion, a second portion, and a third portion,
a second direction being along the medium facing face and crossing the first direction,
a second portion position of the second portion in the second direction being between a first portion position of the first portion in the second direction and a third portion position of the third portion in the second direction,
a first distance along the first direction between the first portion and the second face being shorter than a second distance along the first direction between the second portion and the second face,
a third distance along the first direction between the third portion and the second face being shorter than the second distance, and
at least a part of the magnetic element being between the second portion and the second face.

### (Technical Proposal 15)

The magnetic head according to Technical proposal 14, wherein
the magnetic element does not overlap the first portion in the first direction and does not overlap the third portion in the first direction.

### (Technical Proposal 16)

The magnetic head according to Technical proposal 14 or 15, wherein
the second portion is recessed with respect to the first portion and the third portion.

### (Technical Proposal 17)

The magnetic head according to any one of Technical proposals 14-16, wherein
the second face includes a first opposing portion, a second opposing portion, and a third opposing portion,
a direction from the first portion to the first opposing portion is along the first direction,
a direction from the second portion to the second opposing portion is along the first direction,
a direction from the third portion to the third opposing portion is along the first direction, and
the second opposing portion is recessed with respect to the first opposing portion and the third opposing portion.

### (Technical Proposal 18)

The magnetic head according to Technical proposal 17, wherein
the second face further includes a fourth opposing portion and a fifth opposing portion,
a second opposing portion position of the second opposing portion in the second direction is between a first opposing portion position of the first opposing portion in the second direction and a third opposing portion position of the third opposing portion in the second direction,
the first opposing portion position is between a fourth opposing portion position of the fourth opposing portion and the second opposing portion position in the second direction,
the third opposing portion position is between the second opposing portion position and a fifth opposing portion position of the fifth opposing portion in the second direction,
the first opposing portion protrudes toward the first face with respect to the fourth opposing portion, and
the third opposing portion protrudes toward the first surface with respect to the fifth opposing portion.

### (Technical Proposal 19)

The magnetic head according to any one of Technical proposals 14-18, wherein
the first face further includes a fourth portion and a fifth portion,
the first portion position is between the fourth portion position of the fourth portion in the second direction and the second portion position,
the third portion position is between the second portion position and a fifth portion position of the fifth portion in the second direction,
the first portion protrudes toward the second face with respect to the fourth portion, and
the third portion protrudes toward the second face with respect to the fifth portion.

### (Technical Proposal 20)

A magnetic recording device, comprising:
a magnetic head according to any one of Technical proposals 1-19; and
a magnetic recording medium, the medium facing face facing the magnetic recording medium, and
the magnetic head being configured to record information on the magnetic recording medium.

According to the embodiment, a magnetic recording device that can improve recording density can be provided.

In the specification of the application, “perpendicular” and “parallel” refer to not only strictly perpendicular and strictly parallel but also include, for example, the fluctuation due to manufacturing processes, etc. It is sufficient to be substantially perpendicular and substantially parallel.

Hereinabove, exemplary embodiments of the invention are described with reference to specific examples. However, the embodiments of the invention are not limited to these specific examples. For example, one skilled in the art may similarly practice the invention by appropriately selecting specific configurations of components included in magnetic heads and magnetic recording devices such as magnetic poles, magnetic elements, magnetic layers, non-magnetic layers, controllers, etc., from known art. Such practice is included in the scope of the invention to the extent that similar effects thereto are obtained.

Further, any two or more components of the specific examples may be combined within the extent of technical feasibility and are included in the scope of the invention to the extent that the purport of the invention is included.

Moreover, all magnetic heads and all magnetic recording devices practicable by an appropriate design modification by one skilled in the art based on the magnetic heads and the magnetic recording devices described above as embodiments of the invention also are within the scope of the invention to the extent that the purport of the invention is included.

Various other variations and modifications can be conceived by those skilled in the art within the spirit of the invention, and it is understood that such variations and modifications are also encompassed within the scope of the invention.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the invention.

What is claimed is:

1. A magnetic head, comprising:
a first magnetic pole including a medium facing face and a first face crossing the medium facing face;
a second magnetic pole including a second face, the first face facing the second face in a first direction; and
a magnetic element provided between the first face and the second face, the magnetic element including a first magnetic layer, and a second magnetic layer provided between the first magnetic layer and the second magnetic pole,
the first face including a first portion and a second portion,
a second direction crossing the medium facing face and crossing the first direction,
the first portion and the second portion satisfying one of a first condition and a second condition,
a first portion position of the first portion in the second direction being between a medium facing face position of the medium facing face in the second direction and a second portion position of the second portion in the second direction in the first condition,
the second portion position being between the medium facing face position and the first portion position in the second condition, and
a first distance along the first direction between the first portion and the second face being shorter than a second distance along the first direction between the second portion and the second face.

2. The magnetic head according to claim 1, wherein
the first portion protrudes toward the second face with respect to the second portion.

3. The magnetic head according to claim 1, wherein
the second face includes a first opposing portion and a second opposing portion,
a direction from the first portion to the first opposing portion is along the first direction,
a direction from the second portion to the second opposing portion is along the first direction, and
the first opposing portion protrudes toward the first face with respect to the second opposing portion.

4. The magnetic head according to claim 3, wherein
at least a part of the magnetic element overlaps the first opposing portion in the second direction.

5. The magnetic head according to claim 1, wherein
the first face further includes a third portion,
the second portion position is between the first portion position and a third portion position of the third portion in the second direction, and
a third distance between the third portion and the second face along the first direction is shorter than the second distance.

6. The magnetic head according to claim 5, wherein
the third portion protrudes toward the second face with respect to the second portion.

7. The magnetic head according to claim 5, wherein
the second face includes a first opposing portion, a second opposing portion, and a third opposing portion,
a direction from the first portion to the first opposing portion is along the first direction,
a direction from the second portion to the second opposing portion is along the first direction,
a direction from the third portion to the third opposing portion is along the first direction,
the first opposing portion protrudes toward the first face with respect to the second opposing portion, and
the third opposing portion protrudes toward the first face with respect to the second opposing portion.

8. The magnetic head according to claim 1, wherein
at least a part of the magnetic element overlaps the first portion in the second direction.

9. The magnetic head according to claim 1, wherein
the second direction is perpendicular to the first direction.

10. The magnetic head according to claim 1, wherein
a ratio of an absolute value of a difference between the second distance and the first distance to the second distance is not less than 0.05 and not more than 0.3.

11. The magnetic head according to claim 1, wherein
the magnetic element further includes a first intermediate layer being non-magnetic, the first intermediate layer being provided between the first magnetic layer and the second magnetic layer.

12. The magnetic head according to claim 1, wherein
the first face includes a fourth portion, a fifth portion, and a sixth portion,
a third direction is along the medium facing face and crosses the first direction;
a fifth portion position of the fifth portion in the third direction is between a fourth portion position of the fourth portion in the third direction and a sixth portion position of the sixth portion in the third direction,
a fourth distance along the first direction between the fourth portion and the second face is shorter than a fifth distance along the first direction between the fifth portion and the second face, and
a sixth distance along the first direction between the sixth portion and the second face is shorter than the fifth distance.

13. The magnetic head according to claim 12, wherein
the fifth portion is recessed with respect to the fourth portion and the sixth portion.

14. A magnetic head, comprising:
a first magnetic pole including a medium facing face and a first face crossing the medium facing face;
a second magnetic pole including a second face, the first face facing the second face in a first direction; and
a magnetic element provided between the first face and the second face, the magnetic element including a first magnetic layer, and a second magnetic layer provided between the first magnetic layer and the second magnetic pole,
the first face including a first portion, a second portion, and a third portion,
a second direction being along the medium facing face and crossing the first direction,
a second portion position of the second portion in the second direction being between a first portion position of the first portion in the second direction and a third portion position of the third portion in the second direction,
a first distance along the first direction between the first portion and the second face being shorter than a second distance along the first direction between the second portion and the second face,
a third distance along the first direction between the third portion and the second face being shorter than the second distance, and
at least a part of the magnetic element being between the second portion and the second face.

15. The magnetic head according to claim 14, wherein
the magnetic element does not overlap the first portion in the first direction and does not overlap the third portion in the first direction.

16. The magnetic head according to claim 14, wherein
the second portion is recessed with respect to the first portion and the third portion.

17. The magnetic head according to claim 14, wherein
the second face includes a first opposing portion, a second opposing portion, and a third opposing portion,
a direction from the first portion to the first opposing portion is along the first direction,
a direction from the second portion to the second opposing portion is along the first direction,
a direction from the third portion to the third opposing portion is along the first direction, and
the second opposing portion is recessed with respect to the first opposing portion and the third opposing portion.

18. The magnetic head according to claim 17, wherein
the second face further includes a fourth opposing portion and a fifth opposing portion,
a second opposing portion position of the second opposing portion in the second direction is between a first opposing portion position of the first opposing portion in the second direction and a third opposing portion position of the third opposing portion in the second direction,
the first opposing portion position is between a fourth opposing portion position of the fourth opposing portion and the second opposing portion position in the second direction,
the third opposing portion position is between the second opposing portion position and a fifth opposing portion position of the fifth opposing portion in the second direction,
the first opposing portion protrudes toward the first face with respect to the fourth opposing portion, and
the third opposing portion protrudes toward the first surface with respect to the fifth opposing portion.

19. The magnetic head according to claim 14, wherein
the first face further includes a fourth portion and a fifth portion,
the first portion position is between the fourth portion position of the fourth portion in the second direction and the second portion position,
the third portion position is between the second portion position and a fifth portion position of the fifth portion in the second direction,
the first portion protrudes toward the second face with respect to the fourth portion, and
the third portion protrudes toward the second face with respect to the fifth portion.

20. A magnetic recording device, comprising:
a magnetic head according to claim 1; and
a magnetic recording medium,
the medium facing face facing the magnetic recording medium, and
the magnetic head being configured to record information on the magnetic recording medium.
